(19) United States
(12) Patent Application Publication
(10) Pub. No.: US 2026/0055279 A1
(43) Pub. Date: Feb. 26, 2026

(54) CAMOUFLAGE COATING FORMULATION

(71) Applicant: QINETIQ LIMITED, Farnborough, Hampshire (GB)

(72) Inventors: Louisa Alice LAING, Farnborough (GB); Philip Mark Shryane ROBERTS, Farnborough (GB); Eoin Seiorse O'KEEFE, Farnborough (GB); Tobias Ieuan SMITH, Farnborough (GB)

(73) Assignee: QINETIQ LIMITED, Farnborough, Hampshire (GB)

(21) Appl. No.: 19/102,770

(22) PCT Filed: Aug. 8, 2023
(86) PCT No.: PCT/GB2023/000038

§ 371 Date: Feb. 10, 2025

(30) Foreign Application Priority Data
Aug. 9, 2022 (GB) 2211583.6

(51) Int. Cl. C09D 5/30; C08K 7/00; C09D 5/33; C09D 7/40; C09D 123/00

(52) U.S. Cl. CPC C09D 5/30; C09D 5/004; C09D 7/70; C09D 123/00; C08K 7/00; C08K 2201/003

(57) ABSTRACT

A thermal infrared reflective coating formulation for use as camouflage. The formulation includes a thermal infrared reflective flake and a thermal infrared transparent material. The thermal infrared transparent material includes a polyolefin binder material.

### FIELD

The present invention is concerned with the field of Electro-Optic (EO) camouflage coating formulations, specifically to liquid-applied inks or paints that enable surfaces and objects treated with the coating to control radiant thermal energy arising from said surfaces so as to disguise objects from detectors that are sensitive to a broad spectral range, including the thermal infrared wavelength range.

### BACKGROUND

In some scenarios, objects such as vehicles need to be hidden or concealed by applying camouflage inks or paints to their surfaces. One of the most popular types of camouflage uses patterns of green, brown and grey or black coloured inks or paints to mimic vegetation.

While conventional techniques provide camouflage at visible wavelengths (taken here as 380 nm to 780 nm), sensor technologies are now capable of detecting features at not only the visible wavelengths, but also at infrared wavelengths (IR). Infrared wavelengths include the near-infrared (NIR, taken here as 750 to 1,400 nm), short-wave infrared (SWIR, taken here as 1,400 to 3,000 nm), and thermal infrared (TIR) which itself is divided into two wavelength bands: medium-wave infrared (MWIR, taken here as 3,000 to 8,000 nm), and long-wave infrared (LWIR, taken here as 8,000 to 15,000 nm). In the TIR there is particular interest in the MWIR and LWIR atmospheric transmission windows taken here as 3,000 nm to 5,200 nm and 8,000 to 14,000 nm respectively and denoted here as MWIR 3-5 and LWIR 8-14. Further, modern sensors have high radiance sensitivity and resolution, high spatial resolution and better image processing such that small spatial features can be resolved at all IR wavelengths.

A problem with conventional camouflage coatings is that they are highly emissive (and correspondingly low reflectivity) in the TIR range. As such, they do little to obscure the TIR signature emitted by surfaces to which they are applied. The TIR signature often appears as contrast radiant intensity (CRI), which is detectable relative to the TIR profile of a background environment. As a consequence of this, surfaces that would otherwise be disguised by conventional camouflage coatings. can often be rendered visible relative to background TIR profiles by virtue of their characteristic TIR signatures, when detected by modern sensor technologies.

It is known in the building construction industry to use thermal insulation materials to control the spread of thermal energy in buildings, in an attempt to improve energy efficiency by reducing reliance on heating when in cool environments and reliance on cooling when in warm environments. For that purpose, coatings which comprise metal flake pigments suspended in a binder material have been developed to minimise radiant heat exchange.

WO 2005/007754 QinetiQ describes a highly TIR reflective additive particle of flake for use for example in building paint formulations. Specifically, there is disclosed a TIR reflective metallic flake and a thin, TIR transparent polymer layer which is coated on some or all of the surface of the flake. Paints formulated with these flakes provide high reflectivities partly because the flakes tend to congregate and align as a layer at the binder outer surface.

There is a need for an ink or paint formulation that allows for control of TIR signatures.

### SUMMARY

According to an aspect of the present invention, there is provided a thermal infrared (TIR) reflective coating formulation (e.g. ink or paint) for use as camouflage. The formulation comprises a TIR reflective flake in a substantially TIR transparent material (e.g. which may be coated on some or all of the surface of the flake). The TIR transparent material comprises a polyolefin binder material and optionally a TIR transparent coloured material. The polyolefin binder material may be a water-based micro emulsion film-forming polyolefin binder.

An ink may be defined as a liquid-applied coating for woven and non-woven textiles and similar high flexibility substrates. Paints may be defined as a liquid-applied coating for sheet metals, formed polymer and reinforced polymer surfaces, building materials and similar ridged surfaces.

The reader is to understand that “TIR reflective” means to have high TIR reflectivity, low TIR emissivity and to be opaque to TIR radiation. Accordingly, by virtue of the TIR reflective flakes, the coating formulation may reflect a high proportion of cold sky TIR radiation incident on the coated surface, which may be advantageous to reduce or obscure the TIR signature of a relatively hotter object such as a vehicle. Further, given that highly reflective materials have correspondingly low emissivity, the coating formulation of the present invention can be used to reduce or minimise the TIR energy radiated by the object to be coated. For example, a low emissivity coating at a given temperature will radiate less TIR energy than a coating with comparatively higher emissivity at the same temperature. Thus the coating formulations of the invention will supress TIR radiation and in many cases advantageously reduce the thermal signature from hot objects. Low emissivity coatings in the solar IR band will also reduce solar heating.

The use of a polyolefin binder material is particularly advantageous for camouflage in that it imparts upon the coating formulation physical properties that are suitable for creating patterns on flexible substrates such as, but not limited to, clothing or woven and non-woven textiles generally, polymer films etc. Specifically, by virtue of the polyolefin binder material, the coating formulation is tough but flexible when dried or cured, and does not alter physical properties of the textile on which it may be applied. This is in contrast to hypothetical TIR reflective coatings which use other types of binder material.

While many TIR transparent binder materials, including film-forming organic and inorganic polymers, may occur to a person skilled in the art, the use of a polyolefin binder has been discovered to be particularly effective in this invention. In that regard, the Applicant has recognised that conventional polymer-based binder materials (such as acrylic, alkyds, polyurethanes etc.), which are typically used in ink and paint formulations, characteristically have narrow absorption bands in the MWIR 3-5 micron region and a strong broad absorption in the LWIR 8-14 micron region, rendering them unsuitable for TIR camouflage applications. However, the

Applicant has recognised that polyolefins, which are a group of predominately saturated either linear or branched hydrocarbon polymer materials, do not exhibit such absorption characteristics; it is substantially transparent in the VIS, NIR, SWIR and TIR wavebands. Thus, by using polyolefin instead of other polymer based materials as the binder material, the present invention provides a coating formulation that has high TIR reflectivity and correspondingly low emissivity (by virtue of the flakes), but without suffering absorption losses in the TIR range. Polyolefin based coating formulations can therefore be used for camouflage purposes.

It will be appreciated that by “substantially transparent”, as used herein, it is meant that the material is not necessarily fully transparent but can be somewhat semi-transparent or translucent. For example, some polyolefins have a micro-crystalline structure which makes them semi-transparent or translucent. Correspondingly, the substantially TIR transparent material may be semi-transparent or translucent.

It will be appreciated that, although reflective flake-based insulation paints are known in the field of building construction, their use in the field of camouflage coating formulations of the type described herein is considered to be both novel and inventive in its own right. Indeed, the Applicant has overcome a problem with flake-based building insulation paints, which would otherwise prevent them from being suitable for use in camouflage applications. Specifically, the Applicant has provided a coating formulation that does not suffer from narrow absorption bands in the MWIR 3-5 micron region and a strong broad absorption in the LWIR 8-14 micron region. The building industry is not concerned with the visible appearance or detectability of their insulation coatings at TIR wavelengths.

The coating formulation can take two forms: a wet form in which the coating formulation can be easily applied to a substrate; and a dry form whereby the coating formulation has been air dried or cured so as to adhere to the substrate. In preferred embodiments, the TIR reflective coating formulation is an ink, i.e. a liquid material that forms a contiguous/continuous film through drying, curing or any combination thereof. The ink may be a printing ink that is used to create a printed pattern on a substrate material. The ink is a liquid material that forms a solid film on a substrate that has controlled reflectivity in the thermal infrared range. Printing methods suitable for application on flexible substrates include but are not limited to screen, offset, flexographic, inkjet, and gravure. Other suitable printing methods will occur to knowledgeable practitioners.

The coating formulation can also be used to create patterns for transfer onto shaped or three dimensional surfaces such as, but not limited to, equipment casings and equipment including but not limited to; helmets, radios, weapons. Printing methods suitable for this purpose include, but are not limited to: hydrographic printing, hydrographic dipping, immersion printing, water transfer printing, hot foil printing, and other suitable printing methods known to practitioners.

In embodiments, the coating formulation, in its wet (liquid) form, may comprise at least 35 percentage by weight of polyolefin. Correspondingly the coating formulation, in its dry form, may comprise at least 50 percentage by weight of polyolefin. However, the advantages of the present invention can be realized with concentrations of polyolefin in any quantity in the wet or dry (dried/cured) forms of the coating formulation, such that the invention should not be limited to a specific concentration of polyolefin.

The TIR reflective flake may have a DC electrical resitivity in the range 0.1 to 50 Ω□⁻¹.

The TIR reflective flake may be an aluminium flake or a flake of other metals or alloys including copper, silver, gold, zinc, brass, bronze or stainless steel—other suitable metal and alloy flakes will occur to a person skilled in the art. The TIR reflective flake may be a composite of a metal or alloy and a dielectric substrate flake, for example silver coated silica glass, mica or organic polymer flakes. Other suitable metal and dielectric flake composites will occur to a person skilled in the art. The TIR reflective flake may be a TIR reflecting compound such as a metal oxide, for example tin doped indium oxide. The TIR reflective flake may comprise a TIR reflective compound coated onto a dielectric flake, for example fluorine doped indium oxide coated onto silica glass or mica flakes. Other TIR-reflecting non-metallic flakes and TIR-reflective non-metallic conducting coated dielectric flake composites will occur to a person skilled in the art.

The TIR reflective flake may have a surface texture of less than 1 μm, e.g. 0.2 to 0.4 μm, and a depth-to-pitch ratio of less than 0.5.

The TIR reflective flake may have a diameter or span of 10 to 100 μm, preferably 10-50 μm, further preferably 30-40 μm.

The TIR reflective flake may have a thickness in the range 0.1 to 5 μm, and preferably in the range 0.1 to 2 μm and most preferably in the range 0.15 to 0.5 μm.

The TIR transparent material may comprise a colourant and optionally a visibly opacifying agent.

The TIR transparent material may comprise a matting agent, for example a powdered polyolefin matting agent. In that regard, it is possible that some coating formulations will have a glossy appearance and therefore gleam or glint. However, by using a matting agent, it is possible to control gloss level and reduce gleam/glint or remove it entirely.

The TIR transparent material may comprise hollow particles. This may increase scattering through the material to control a gloss level of the coating formulation.

The TIR transparent material may further comprise a cross-linking agent additive.

The TIR transparent material may further comprise one or more surfactants and rheological modifiers.

The formulation may comprise, in wet form, 1-20 percentage by weight of TIR reflective flakes. Correspondingly, the formulation may comprise, in dry form, 1-40 percentage by weight of TIR reflective flakes.

The formulation may comprise 1-10 percentage by weight of coloured pigment.

The TIR reflective flake may be coated by a coloured pigment. This may reduce the metalic apperance of the coating formulation and reduce gleam/glint.

The formulation, in wet form, may comprise:
10% by weight of aluminium flakes;
4% by weight of a colour material, e.g. perylene black;
2% by weight of rheological modifiers;
2% by weight of a cross linking agent; and
82% by weight of the polyolefin binder material, wherein the binder material comprises 44% by weight of polyolefin.

According to a further aspect of the present invention, there is provided a camouflaged article having a (e.g. textile) surface which is coated by the formulation described above in any preceding statement.

According to a further aspect of the present invention, there is provided a set of plural camouflage coating formulations, wherein:
each coating formulation respectively is a TIR reflective coating formulation in accordance with any preceding statement;
a first coating formulation comprises a first concentration (e.g. percentage by weight or volume of the coating formulation) of TIR reflective flakes and a second coating formulation comprises a second concentration (e.g. percentage by weight or volume of the coating formulation) of TIR reflective flakes; and
the first concentration is greater than the second concentration, such that the first coating formulation will exhibit greater TIR reflectivity than the second coating formulation.

The Applicant believes that a set of camouflage coating formulations having different concentrations of TIR reflective flakes may be novel and inventive in its own right, irrespective of which binder material is used. Thus, according to a further aspect of the present invention, there is provided a set of plural camouflage coating formulations, each coating formulation comprising TIR reflective flakes in a substantially TIR transparent material; wherein a first coating formulation of the set comprises a first concentration (e.g. percentage by weight or volume of the coating formulation) of TIR reflective flakes and a second coating formulation of the set comprises a second concentration (e.g. percentage by weight or volume of the camouflage coating formulation) of TIR reflective flakes. The first concentration may be greater than the second concentration, such that the first coating formualtion will exhibit greater TIR reflectivity than the second coating formulation.

For both aspects, the first coating formulation and the second coating formulation may have the same visible colour. In such arrangmeents, the set may be used to form a camouflaged article having a surface region which is covered with a single visible colour but a complex pattern in the TIR range. In other embodiments, however, the first coating formulation and the second coating formulation may have different visible colours.

The first coating formulation and the second coating formulation may have the same gloss level. For example they may have the same concentration of one or more of matting agents and hollow particles. Alternatively, the first coating formulation and the second coating formulation may have different gloss levels. For example they may have different concentrations of matting agents and/or hollow particles. The provision of coating formulations having different gloss levels enables another form of disruptive camouflage patterning. This may be advantageous for breaking up the outline of an object, particularly at lower angles of incidence.

According to a further aspect of the present invention, there is provided a set of plural camouflage coatings, wherein:
each coating respectively comprises a TIR reflective coating formulation described herein with respect to any of the preceding statements; and
a first coating formulation and a second coating formulation have the same concentration of TIR reflective flakes, such that the first coating formulation will exhibit the same TIR reflectivity as the second coating formulation.

The first coating formulation and the second coating formulation may have different visible colours. In such arrangmeents, the set may be used to form a camouflaged article having a surface region which is covered with a complex colour pattern but a uniform signature across the surface region in the TIR range. In other embodiments, however, the first coating formulation and the second coating formulation may have the same visible colour.

The first coating formulation and the second coating formulation may have the same gloss level. For example they may have the same concentration of one or more of matting agents and hollow particles. Alternatively, the first coating formulation and the second coating formulation may have different gloss levels. For example they may have different concentrations of matting agents and/or hollow particles. By virtue of coating formulations having different gloss levels, the invention enables another form of disruptive camouflage patterning. This may be advantageous for breaking up the outline of an object, particularly at lower angles of incidence.

The (e.g. first and second) concentration(s) of TIR reflective flakes referred to above may be the percentage by weight or percentage by volume of TIR reflective flakes in the respective camouflage coating(s) in wet or dry form.

The Applicant believes that a set of camouflage coating formulations having different gloss levels may be novel and inventive in its own right. Thus according to another aspect of the inventoin, there is provided a set of plural camouflage coating formulations, wherein a first coating formulation of the set has a first gloss level and a second coating formulation of the set has a second gloss level different to the first gloss level.

According to a further aspect of the present invention, there is provided a method of making a TIR reflective coating. formulation, comprising: providing a substantially TIR transparent material mixture comprising a liquid dispersion of polyolefin; and subsequently dispersing a TIR reflective flake into the TIR transparent material mixture.

The substantially TIR transparent material mixture may comprise a TIR transparent coloured material, wherein the TIR transparent coloured material, e.g. pigment, may be, e.g. ball or sand, milled into the liquid dispersion of polyolefin to form the substantally TIR transparent material mixture.

At least one, and in embodiments each, surface of the TIR reflective flake may be coated by a TIR transparent coloured material in a rotary tumbling process; and the coated TIR reflective flake may be dispersed into the TIR transparent material mixture.

Dispersing a TIR reflective flake into the TIR transparent material mixture may comprise mixing the TIR reflective flake into the TIR transparent material mixture using a double planetary mixer. It has been found that using double planetary mixing may efficiently disperse the TIR reflective flake without causing damage to or distorting the TIR reflective flake, whereas methods widely employed in ink and paint formulation such as ball milling and sand milling can lead to the TIR reflective flakes being damaged, distorted or forming agglomerated clumps.

Further still, according to another aspect of the present invention, there is provided a thermal infrared (TIR) reflective coating formulation (e.g. ink or paint) for use as camouflage. The formulation comprises a TIR reflective flake in a substantially TIR transparent material (which may be coated on some or all of the surface of the TIR reflective flake). The TIR transparent material may comprise a substantially TIR transparent coloured material and a TIR transparent binder material.

According to a further aspect of the present invention, there is provided a method of making a camouflaged article, comprising: applying a coating formulation of any preceding statement or aspect to a surface of an article to be camouflaged; and air drying and/or curing the formulation.

Air drying may be defined as non-forced solvent evaporation to form a contiguous binder film that adheres the TIR reflective flake and optional colouring materials to a substrate material, i.e. the surface.

The surface of an article may be a non-tir reflective surface.

The step of applying the coating formulation to a surface of an article may comprise applying the coating formulation as a plurality of dots which are distributed across the surface so as to define: a first surface region having a first dot density; and a second surface region having a second dot density which is different to the first dot density. Correspondingly, in embodiments of the camouflaged article described above, the formulation coats a surface of the camouflaged article as a plurality of dots which are distributed across the surface so as to define: a first surface region having a first dot density; and a second surface region having a second dot density which is different to the first dot density. The dot density may be defined as the number of individual dots per unit of surface area, e.g. the number of dots in the surface region in question. It may also be defined as the volume of the coating formulation (e.g. of the ink or paint) deposited (as dots) in the unit of surface area.

The first and second surface regions may be different regions of the surface, but having equal surface area, to allow for an accurate comparison of dot densities in those regions. The coating formulation may be the same in both surface regions. That is, the dots in each surface region may have the same concentration of TIR reflective flakes.

The first dot density may be higher than the second dot density, such that the first surface region will exhibit greater TIR reflectivity than the second surface region.

The Applicant considers this dot-density application method and camouflaged article to be novel and inventive in their own right, e.g. irrespective of the binder material used. Thus, according to a further aspect of the present invention, there is provided a camouflaged article having a surface which is coated by a camouflage coating formulation as a plurality of dots which are distributed across the surface so as to define: a first surface region having a first dot density; and a second surface region having a second dot density which is different to the first dot density.

According to a further aspect of the present invention, there is provided a method of forming a camouflaged article, wherein the method comprises: applying a camouflage coating formulation to a surface of an article as a plurality of dots, wherein the dots are distributed across the surface so as to define: a first surface region having a first dot density; and a second surface region having a second dot density which is different to the first dot density.

The camouflage coating formulation is a thermal infrared (TIR) reflective coating formulation (e.g. ink or paint). For example, the formulation comprises a TIR reflective flake in a TIR transparent material. The TIR transparent material may comprise a TIR transparent coloured material and a TIR transparent binder material. Any binder material can be used, such that the invention is not limited to the polyolefin binder material described above.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments of the invention will now be described by way of non-limiting example with reference to the remaining drawings, in which:

FIG. 1 is a schematic drawing illustrating a scene in which the invention may be used;

FIG. 2 is a schematic diagram of a scanning electron microscope image of an ink formulation in accordance with an embodiment of the present invention;

FIG. 3 is a graph showing an idealised modelled spectral reflectivity profile for ink coating formulations in accordance with an embodiment of the present invention;

FIG. 4 is a graph showing a simplified spectral reflectivity profile for conventional ink coating formulations;

FIG. 5 is a flow chart illustrating a method of manufacturing a coating according to an embodiment of the present invention; and

FIG. 6 is a schematic diagram illustrating an example embodiment of a camouflaged article in accordance with an embodiment of the present invention.

### Like reference numerals will be used throughout the detailed description to denote like features of the invention.

### DETAILED DESCRIPTION

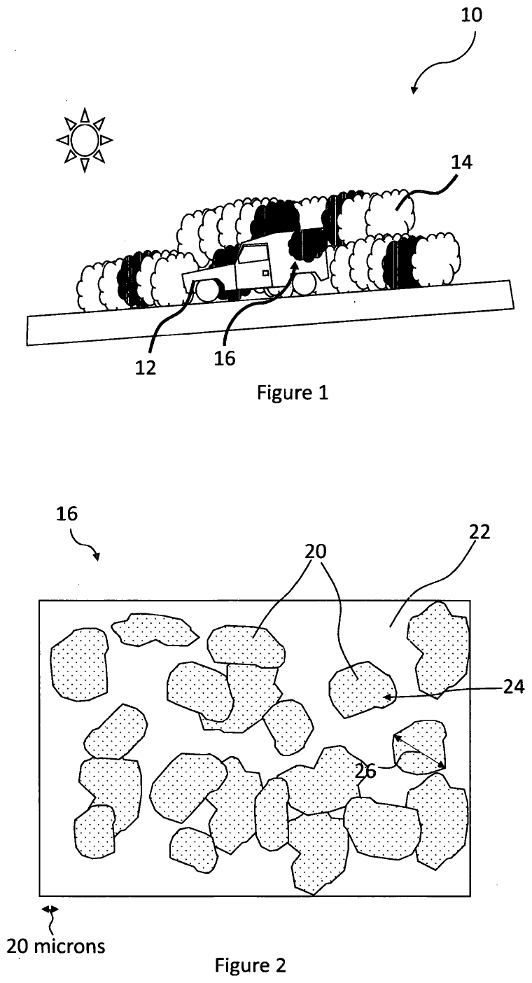

FIG. 1 is a schematic drawing illustrating a typical scene 10 in which the camouflage coating formulation of the present invention is to be applied.

The scene 10 is of a landscape comprising natural and man-made objects. In the current example, the scene 10 comprises a man-made object in the form of a vehicle 12 which forms part of the foreground of the scene 10, and a temperate woodland environment which forms the background. The vehicle 12 has a mobile camouflage system which is a textile (e.g. cotton) coated wholly or in parts with a dried, printed form of the camouflage coating formulation 16. The camouflage coating forms a large bold contrasting pattern to disrupt the outline of the vehicle 12 to the observer.

Conventional camouflage coating formulations are used to form disruptive patterns when observed using visible and NIR band techniques only. At TIR wavelengths, however, the conventional coating formulations provide little contrast to each other or the object on which they are applied, and therefore do not disrupt the TIR signature arising from the surfaces to which they are applied to break up the outline of the vehicle, in this example. In contrast to this, the coating formulation of the present invention is able to control the TIR signature of an object, thereby providing a disruptive thermal pattern to break up the outline of the object.

FIG. 2 schematically illustrates a scanning electron microscope image of a coating formulation in the form of an ink 16 in dry form, in accordance with an embodiment of the present invention.

As can be seen in FIG. 2, the ink 16 comprises a plurality of TIR reflective metallic flakes 20 suspended in a substantially TIR transparent material 22. In this embodiment, the TIR reflective flakes 20 (which may be referred to hereafter as “the flake(s)”) are entirely encapsulated or coated by the TIR transparent material 22. The flakes 20 are dispersed throughout the transparent material 22.

Each flake 20 may be regarded as a thin, flat piece of TIR reflective material in that it generally has the form of two substantially planar surfaces 24 on either side of the flake 20 (only one of which is shown for each flake in FIG. 2) and an edge extending along the perimeter of the flake 20 between the two planar surfaces 24. The thickness of the flake 20, as measured from one planar surface 24 to the other along the edge, is substantially smaller than a span 26 of the planar surface 24.

Although FIG. 2 shows flakes 20 oriented such that their substantially planar surfaces 24 are outwardly facing, in practice the flakes will have a distribution of orientations with respect to the outer surface, thereby providing diffuse reflectance. This is in contrast to flake-based formulations where the flakes tend to congregate and align as a layer at the binder outer surface to provide specular reflection. Diffuse reflectance may be advantageous for camouflage purposes in that it will average the reflected radiation from the scene, matching the background which also tends to be diffuse from a wide range of observation locations and viewing points.

The TIR reflective flake 20 comprises either metallic or conductive oxide material or composites with dielectric substrate flakes, particularly those with low TIR emissivity and thus high TIR reflectivity. The TIR reflective flake 20 is preferably formed of aluminium because it has been found to reflect the majority of incident TIR radiation while having low toxicity, chemical compatibility with binder and colourants, being widely availble at low cost and with preferred physical properties including dimensions, modulus, yield strength and elastic limit. Aluminium flakes with a DC electrical resistivity in the range 0.1 to 50Ω□⁻¹, ideally less than 10Ω□⁻¹.

The flakes 20 are sufficiently thick to reflect the majority of incident TIR radiation. However, the thickness should be minimised to reduce high angle scatter of TIR radiation which may occur as a result of flake edge scattering through the ink formulation. In that regard, rays that are scattered at high angles may travel through more of the binder material or reflect from other flakes before they leave the coating, thereby increasing their path length through the binder material and thus the extent of energy that is lost due to absorption by the binder material (which yields a significant reduction in TIR reflectivity). In embodiments the flakes may have a thickness in the range 0.1 to 5 μm, and preferably in the range 0.1 to 2 μm. In this embodiment, where the flakes 20 are formed of aluminium material, the thickness of the flakes is in the range 0.15 to 0.5 μm. The range 0.3 to 0.4 μm has been found to be particularly preferable. However, the optimum thickness may vary for different flake materials.

The substantially planar surfaces 24 are sufficiently smooth to provide adequate levels of TIR reflection. By way of contrast, a comparatively rough surface will scatter TIR radiation and reduce its TIR reflectivity. On a microscopic level, the planar surface of the flake 20 may deviate from a perfectly flat ideal case (i.e. a true plane) in that it has small, local deviations having a shape that approximates a series of peaks and valleys. A smoothness of the surface may be determined by measuring a ratio of the depth of adjacent valleys and their pitch. Accordingly, the substantially planar surfaces 20 have a depth to pitch ratio of less than 0.5. Further, the size of these local deviations or surface textures are less than 1 μm, preferably in the range 0.2 μm to 0.4 μm.

The area of the planar surfaces 24 of the flake 20 has an effect on the TIR reflectivity. If the span is small compared to the wavelength of radiation then loss through scattering mechanisms become important. The average span 26 of the flake 10 is therefore greater than 20 μm. Further, the average span 26 is less than 100 μm because larger flakes can block the screens used in screen printing methods. An average span 26 of less than 100 μm avoids the need for the printer to have a larger gap screen having larger diameter screen threads, which would otherwise be needed to compensate for larger flakes. In this way, it is possible to print a thinner layer of ink onto a substrate thereby reducing final print weight, which can be desirable for textile applications.

Further still, flakes above around 50 μm become resolvable by the human eye and so in this embodiment the flake span 26 is in the range 10-50 μm, where the range 30-40 μm is more preferable.

In the present embodiment, the TIR transparent material 22 comprises a binder material and a coloured material. This provides visual colour and mechanical strength to the formulation, together with chemical and environmental protection for the aluminium flake 20.

The binder material must be substantially transparent to transmit TIR radiation through to the reflective flakes and back out without significant loss. This material therefore comprises an organic film forming polymer with low TIR absorption. Specifially, the substantially TIR transparent material comprises a polyolefin binder material. The polyolefin binder material, in its liquid state before drying, is a liquid dispersion of micron-sized polyolefin particles, such as polyethylene and polypropylene, and/or block copolymers with significant polyolefin content, such as Kraton's G SEBS (Styrene-ethylene/Butylene-styrene) and SEPS (Styrene-ethylene/Propylene-styrene), and/or cyclic olefin polymers (COP, for example Zeon Chemicals' ZEONIX™) and cyclic olefin copolymers (COC, for example Mistui Chemicals Europe's APEL™).

Different polyolefin binder dispersions may have different concentrations of polyolefin particles. However, one example of a polyolefin binder dispersion used in the present invention is the so-called “CANVERA™ 1110 Polyolefin Dispersion”, which comprises 44 percentage by weight of acid-modified polyolefin particles or “CANVERA™ 1350 Polyolefin Dispersion”, which comprises 46 percentage by weight acid modified polyolefin particles. These dispersions may be purchased from The Dow Chemical Company. Other examples of a suitable polyolefin binder dispersion is the so-called “CHEMIPEARL™”, grade “M” or “W”, polyolefin-based aqueous dispersion, which is manufactured by Mitsui Chemicals Europe GmbH.

The coloured material includes visible band colourants such as coloured pigments (and optionally opacifying pigments) chosen for high specific absorption in the visible waveband, associated with electronic transitions, but weak specific absorption at TIR wavelengths due to molecular vibration. That is, the coloured material is selected to have substantially no absorption in the MWIR 3-5 and LWIR 8-14 wavebands and used at combinations of concentration and optical path lengths such that they do not substantially reduce MWIR 3-5 and/or LWIR 8-14 transmission in the coating formulation. Desirable coloured pigments include pigments such as organic perylenes, e.g. perylene black, Fe-Cr oxides, chrome antimony titanium rutiles, disazos and quinophthalones. One example of an opacifying pigment is zinc sulphide. Other suitable coloured materials will occur to a suitably skilled person. In this way the visual, camouflage colour requirements can be met without significant reduction of TIR transparency.

The Applicant has recognised that some camouflage coating formulations described herein can appear glossy, and in some cases gleam or glint and appear metallic in colour owing to the (e.g. metal) material used for the TIR reflective flakes.

To reduce gloss levels, a commercial-off-the-shelf (COTS) matting agent may be added to the TIR transparent material 22 to modify the surface properties of the formulation. The matting agent may be a powdered polyolefin matting agent.

In additional or alternative embodiments, the TIR transparent material 22 comprises hollow particles, for example hollow plastic spheres. Such hollow particles have been found to be particularly effective for reducing gloss levels. For example, the air voids within the particles tend to scatter light efficiently to matt the coating.

In another additional or alternative embodiment, the TIR reflective flakes 20 themselves may be wholly or partly coated with a TIR transparent coloured pigment which may be in addition or an alternative to coloured pigments added to the polyolefin dispersion. This pigment coating may reduce the surface area of the flakes that will be exposed in the coating formulation, thereby reducing its metallic appearance and gleam/glint. The coloured pigment may be coated onto the flakes in a rotary tumbling process. Specifically, the TIR reflective flakes 20 are added to a rotatable barrel together with coloured pigments and a mixing media, and the barrel is driven in rotation to cause its contents to tumble upon itself causing friction and abrasion. This causes the coloured pigment to break down, intimately mix and loosely attach (e.g. via electrostatic attraction) to the relatively harder and denser flakes 20 to coat them. Any dense material may be used as the mixing media. However, in embodiments, Zirconia spheres are used. The Zirconia spheres may have a diameter of 8-10 mm which can provide optimal dispersion of the coloured material while minimizing comminution of the flakes.

In the formulations of the invention different proportions of constituent components are desired depending on: the desired liquid properties for the chosen printing process; the optical and thermal infrared properties required in the dry form (e.g. the dry printed film); and the characteristics required for the printed article including, but not limited to: adhesion of the ink to substrate materials, ink flexibility, ink weight, ink abrasion resistance, ink fire resistance, ink water resistance, ink UV resistance.

Further, the concentration of one or more of matting agents and hollow particles (or some other additive which would be apparent to the skilled persion) may be tailored such that the coating formulation has a desired gloss level. For example, different coating formulations may have different gloss levels to enable another form of disruptive camouflage patterning. This may be advantageous for breaking up the outline of an article, particularly at lower angles of incidence.

One example of a suitable wet ink formulation, which has a TIR emissivity in the range 0.15-0.2 (and thus TIR reflectivity of 0.85-0.80) is:
10 wt. % of TIR reflective Aluminium flakes (Eckart IReflex);
4 wt. % of coloured pigment, in this example perylene black (Sun Chemical Spectrasense Black L 0086);
2 wt. % of rheological modifiers (BYK-375);
2 wt. % of a cross linking agent (EMS-Griltech Primid QM-1260); and
82 wt. % of polyolefin binder dispersion (Dow Canvera 1110), i.e. 36.08 wt. % of polyolefin particles and 45.92 wt. % aqueous solution.

The formulation may be formed by milling the constituent components save for the Aluminium flakes, and then mixing in the Aluminium flakes using a low impact process such as a planetary centrifugal pot mixer e.g. the so-called ‘Thinky mixer’ (thinkymixer.com).

It will be appreciated that the final, dry form of the coating formulation will have a greater concentration of polyolefin particles and TIR reflective flakes compared to that of the same coating formulation in its wet form, because water in the polyolefin binder dispersion will evaporate from the formulation and be lost during the drying process. Accordingly, the same ink formulation, in its dry form, comprises:
18.5 wt. % of TIR reflective (aluminium) flakes (Eckart IReflex);
7.4 wt. % of coloured pigment, in this example perylene black (Sun Chemical Spectrasense Black L 0086);
3.7 wt. % of rheological modifiers (BYK-375);
3.7 wt. % of a cross linking agent (EMS-Griltech Primid QM-1260); and
66.7 wt. % of polyolefin.

The thermal reflectivity of the camouflage ink formulation can be tailored by appropriate selection of a concentration (e.g. percentage by weight or percentage by volume) of the TIR reflective flakes. Further, by tailoring the concentration of reflective flakes, it is possible to manufacture plural inks that demonstrate higher TIR reflectivity contrast between them. For example, a set of plural inks may be formulated with different TIR reflectivities to be printed in various regular or irregular patterns or gradations to break up treated object outlines and/or to improve matching of the treated object to the spatial variations in apparent temperature that occur in the background found where camouflage is used. Further, plural inks with different TIR reflectivities can be used to create disruptive TIR camouflage patterns.

Further, the TIR reflective ink can have any colour and so the TIR pattern and the visual pattern can be quite different. For example, a combination of different inks can be used to provide camouflage where the TIR pattern is larger than (or differently shaped to) the visual pattern. Thus by being able to alter the reflectivity independently of the colour of the inks, the present invention provides the ability to create patterns of both visible colours and TIR emissivity and to vary these two characteristics independently for different applications.

Accordingly, a first ink formulation of a set of plural ink formualtions may comprise a first concentration (e.g. percentage by weight or volume) of TIR reflective flakes, and a second ink formulation of the set may comprise a second concentration (e.g. percentage by weight or volume) of TIR reflective flakes, where the first concentration is greater than the second concentration. In this way, the first ink formulation will exhibit greater TIR reflectivity than the second ink formulation, to increase the TIR signature contrast between the first and second inks. The first ink formulation and the second ink formulation may have the same visible colour, e.g. colourant content, thereby allowing one to create a TIR pattern that is different to the visible colour pattern. For example, there may be two or more colour matched ink formulations, each one having a different TIR reflective flake concentration, e.g. percentage by weight or percentage by volume, where the flake concentrations range from a relatively lower concentration to a relatively higher concentration (e.g. in a gradated manner). Alternatively, the first ink formulation and the second ink formulation may have different visible colours (or shades of the same colour), e.g. by virtue of different coloured materials or different concentrations thereof.

Another set of plural inks may comprise first and second ink formulations, where both ink formulations have the same concentration (e.g. percentage by weight or volume) of TIR reflective flakes, but different visible colours e.g. colourant content.

Such arrangements may be advantageous to independently match the visible camouflage pattern with the visible appearance of the background and match the TIR camouflage pattern with the TIR appearance of the background.

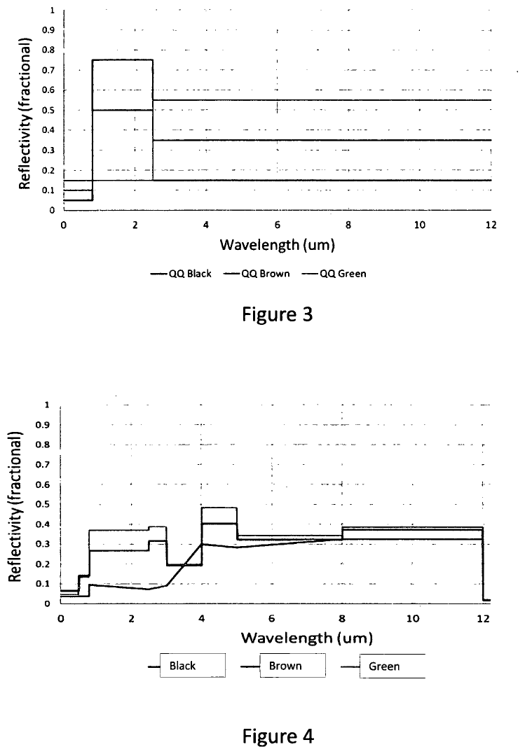

FIG. 3 is a graph showing an idealised modelled spectral reflectivity profile for camouflage ink formulations in accordance with embodiments of the present invention; there is shown a black ink, a brown ink, and a green ink. The visibly darkest ink, the black ink, has high NIR reflectivity to minimise solar heating and highest emissivity to maximise heat loss; the lightest visible colour ink (green ink) has low NIR reflectivity and emissivity so as to provide contrast in the NIR and TIR spectral bands. A simplified spectral reflectivity spectrum of conventional camouflage inks are shown for comparison in FIG. 4—as can be seen, such inks have low contrast across the NIR to LWIR bands for the three colours.

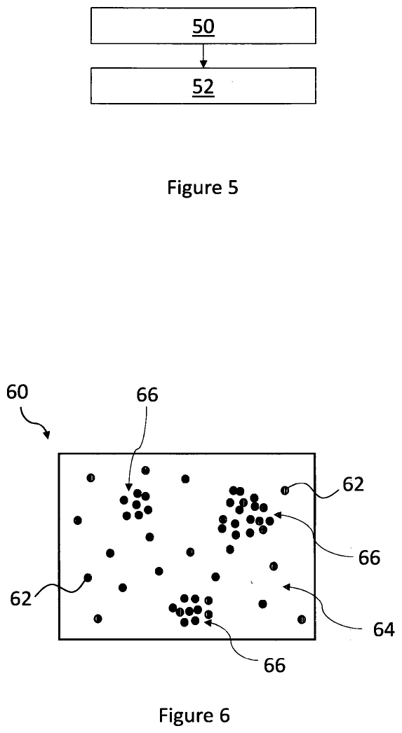

A coating according to the present invention can be formed in a variety of ways but a preferred method of manufacturing a coating formulation is described with reference to FIG. 5. The example is described with respect to making an ink formulation, although it applies equally to making paint formulations.

The ink formulation is formed by first forming, at step 50, the substantially TIR transparent material. This is done by mixing the TIR transparent coloured material and additives (rheological modifiers and cross-linking agent) with the polyolefin binder material (the polyolefin binder dispersion). The coloured material is, e.g. ball or sand, milled into the polyolefin binder material at this stage to ensure the coloured material is dispersed before the flake is introduced.

At step 52, and subsequent step 50, the TIR reflective flakes are dispersed into and throughout the TIR transparent material mixture. This is done using a double planetary mixer to disperse the flake without comminution or distortion. In this way, the flakes 20 will have a varied distribution of orientations with respect to the surface throughout the TIR transparent material, to provide diffuse reflectance.

The ink formulation may then be used to make a camouflaged article. This may include the steps of applying the wet ink formulation to a surface of an article to be camouflaged and air drying and/or curing the or ink or paint formulation. In embodiments the wet ink formulation is air dried and then cured at 180° C. for 20 minutes. In this process, water present in the polyolefin binder dispersion is evaporated or otherwise lost to the environment and the polyolefin particles coalesce into a contiguous film. The ink thickness in its dry form may vary within a textile material. For example, it may have a thickness of 25-40 microns above the weave structure, and up to 100-125 microns between the weave structures.

The method has been described above with respect to mixing the TIR transparent coloured material and additives (rheological modifiers and cross-linking agent) with the polyolefin binder material (the polyolefin binder dispersion) to form the TIR transparent material. However it will be appreciated that, in embodiments where the TIR reflective flakes are themselves coated with a coloured pigment, the method of FIG. 5 may instead comprise: providing a TIR transparent material mixture in the form of a liquid dispersion of polyolefin; and subsequently dispersing the TIR reflective flakes coated with a colourant into the TIR transparent material mixture. That is, it is not necessary to disperse a coloured pigment into the polyolefin binder dispersion if the TIR reflective flakes are themselves coated with a coloured pigment.

FIG. 6 is a schematic diagram illustrating an example embodiment of a camouflaged article in accordance with an embodiment of the present invention.

In the present embodiment, the article is in the form of a textile having a surface 60 which has been coated with the camouflage coating formulation. The camouflage coating formulation is an ink as described above with respect to FIGS. 1 to 5.

In the embodiment of FIG. 6, the ink has been deposited across the surface 60 of the textile (e.g. in screen, offset, flexographic, inkjet or gravure printing process) as a plurality of small volumes of material on the surface 60. The volumes of material form a single layer on the surface 60 of the textile, and are therefore in-plane. The distribution is such that the ink occupies discrete areas of the surface 60, for example in the form of dots 62, which may have a random or predetermined shape as appropriate. At least some of the dots 62 have a spacing between them so as to define surface areas 64 which are not coated by the ink.

The dot distribution defines surface regions 66 having a relatively high dot density, as compared to one or more other surface regions. The dot density (number of dots or volume per unit of surface area) can be tailored across the surface 60 by modifying any one or more of dot size, dot shape, etc. The precise local distribution of dots may be regular, or regularly varying (if a graded emissivity/reflectivity property is required on the surface 60), or may be random.

In this way, a surface property such as emissivity/reflectivity can be varied locally as a function of position on the surface 60 using the same ink formulation, i.e. without having to use coating formulations with different concentrations of reflective pigments. For example, a surface region 66 having a high dot density will have lower emissivity (and thus higher reflectivity) than a surface region having a relatively lower dot density. Such variation may be linear or non-linear, including stepwise, and may be obtained by varying the local density of the camouflage coating formulation material (e.g. dot density). Similar effects can be obtained by varying dot size, shape and/or spacing. The surface regions 66 may form patterns to break up an object outline and/or to improve matching of the article to TIR signature of the background where the article is to be used.

This embodiment therefore provides the ability to alter the emissivity/reflectivity of a surface using only a single layer of ink. This is in contrast to hypothetical arrangements where coating formulations with different loadings of metal flake are layered to produce different reflectivity/emissivity patterns onto a textile.

Further by depositing the coating formulation as dots, where at least some of the dots have a spacing between them so as to define regions of the textile which are not coated, the reflectivity/emissivity properties can be tailored cross the surface areas while increasing breathability and flexibility of the textile. This also, in turn, reduces rustling of the textile caused by movement and increases user comfort.

In a variant of the present invention, the TIR reflective coating formulation can be made to be optically transparent. This is achieved by omitting the coloured material and by forming the flakes from a conductive oxide material instead of aluminium, as the conductive oxide material is transparent at visual wavelengths but remains reflective in the TIR band. Examples of suitable material include, but are not limited to, indium and fluorine doped tin oxides (ITO, FTO). Further examples of materials that are optically transparent in this way are very thin layers of silver, gold, copper or their alloys. In using these materials, a clear and, if required, colourless highly TIR reflective varnish can be made. This may be advantageous in arrangements where a fabric material is printed with conventional colour inks to form a disruptive camouflage pattern, but is then coated with the TIR reflective varnish for TIR camouflage purposes.

It will be appreciated that while the invention has been described above with respect to a camouflage coating formulation in the form of an ink, the present invention is equally applicable to paint formulations instead of inks. For example, a paint formulation may comprise a TIR reflective flake in a substantially TIR transparent material, wherein the TIR transparent material comprises a polyolefin binder material (and optionally a TIR transparent coloured material). However, the paint formulation may further comprise rheological modifiers to reduce its viscosity if necessary.

It will be appreciated that whilst various aspects and embodiments of the present invention have heretofore been described, the scope of the present invention is not limited to the embodiments set out herein and instead extends to encompass all methods and arrangements, and modifications and alterations thereto, which fall within the scope of the appended claims.

1. A thermal infrared (TIR) reflective coating formulation for use as camouflage, wherein the formulation comprises a TIR reflective flake in a substantially TIR transparent material; wherein the TIR transparent material comprises a polyolefin binder material.

2. The formulation of claim 1, wherein the TIR reflective flake has a DC electrical resitivity in the range 0.1 to 50 Ω□⁻¹ .

3. The formulation of claim 1, wherein the substantially TIR transparent material comprises hollow particles to scatter visible light passing therethrough.

4. The formulation of claim 1 wherein the TIR reflective flake has a surface texture of less than 1 μm, and a depth-to-pitch ratio of less than 0.5.

5. The formulation of claim 1 wherein the TIR reflective flake has a diameter or span of 10 to 100 μm.

6. The formulation of claim 1 wherein the TIR reflective flake has a thickness in the range 0.1-5 μm.

7. The formulation of claim 1 wherein the substantially TIR transparent material comprises a TIR transparent coloured material which comprises a colourant and optionally a visibly opacifying agent.

8. The formulation of claim 1, wherein the formulation comprises: in wet form, 1-20 percentage by weight of TIR reflective flakes; or in dry form, 1-40 percentage by weight of TIR reflective flakes.

9. The formulation of claim 1, wherein the formulation comprises 1-10 percentage by weight of coloured pigment.

10. The formulation of claim 1, wherein the formulation comprises: in its wet form, at least 35 percentage by weight of polyolefin; or, in its dry form, at least 50 percentage by weight of polyolefin.

11. The formulation of claim 1, wherein the TIR reflective flake is coated by a TIR transparent coloured pigment to reduce the surface area of the flake which is exposed to visible light.

12. A camouflaged article having a surface which is coated by the formulation of claim 1.

13. A camouflaged article having a surface which is coated by the formulation of claim 1, wherein:
the formulation coats a surface of the camouflaged article as a plurality of dots which are distributed across the surface so as to define: a first surface region having a first dot density; and a second surface region having a second dot density which is different to the first dot density; and
the first dot density is higher than the second dot density, such that the first surface region will exhibit greater TIR reflectivity than the second surface region.

14-18. (canceled)

19. A method of making a TIR reflective coating formulation, comprising: providing a substantially TIR transparent material mixture comprising a liquid dispersion of polyolefin; and subsequently dispersing a TIR reflective flake into the substantially TIR transparent material mixture.

20. The method of claim 19, wherein the substantially TIR transparent material comprises a TIR transparent coloured material, wherein the TIR transparent coloured material is milled into the liquid dispersion of polyolefin to form the TIR transparent material mixture.

21. The method of claim 19, wherein a surface of the TIR reflective flake is coated by a TIR transparent coloured material in a rotary tumbling process; and the coated TIR reflective flake is dispersed into the substantially TIR transparent material mixture.

22. The method of claim 19, wherein dispersing a TIR reflective flake into the substantially TIR transparent material mixture comprises mixing the TIR reflective flake into the substantially TIR transparent material mixture using a double planetary mixer.

23. (canceled)

24. The coating formulation of claim 1, wherein the flakes have varied orientations throughout the TIR transparent material, such that the coating formulation will exhibit diffuse reflectance.
